(19) United States
(12) Patent Application Publication
(10) Pub. No.: US 2003/0069960 A1
(43) Pub. Date: Apr. 10, 2003

(54) Method for describing and comparing data center physical and logical topologies and device configurations

(76) Inventors: Julie A. Symons, Santa Clara, CA (US); Sharad Singhal, Belmont, CA (US)

Correspondence Address: HEWLETT-PACKARD COMPANY, Intellectual Property Administration, P.O. Box 272400, Fort Collins, CO, 80527-2400, US

(21) Appl. No.: 09/971,857

(22) Filed: Oct. 4, 2001

(51) Int. Cl. G06F 15/173

(52) U.S. Cl. 709/224; 709/223

(57) ABSTRACT

A method for describing and comparing data center physical and logical topologies and device configurations. The present invention compares a stored expected network infrastructure description with a current network infrastructure description gathered through the use of monitoring agents. The infrastructure descriptions are compared to discover any differences between the expected infrastructure and the current infrastructure. Devices in the current infrastructure which are configured differently, added, or missing from the expected infrastructure description are listed as well as changes to the logical topology of the current network. The present invention facilitates monitoring the network infrastructure and detecting unauthorized changes or access to the network.

### FIELD OF THE INVENTION

The present invention relates to the field of computer network management. More specifically, the present invention pertains to a method of comparing an expected network configuration to the current network configuration and reporting discrepancies.

### BACKGROUND OF THE INVENTION

Most network management tools currently used in data centers monitor and display the current state of the network infrastructure. The expected network infrastructure is either not known or not maintained. It is left to the network operators to decide if something is wrong with the infrastructure description. This system is error prone, especially in large environments.

Computer networks can easily include thousands of devices, each of which may have multiple connections as well as configuration information which needs to be displayed. Existing network management tools can provide huge amounts of data to a network operator. However, in displaying all of this information, a network operator can easily become overwhelmed by too much information. Furthermore, it is difficult to display all of this information at one time making it difficult for the operator to make any comparisons. Given the vast amount of information that may be presented, it would be virtually impossible for the network operator to detect any changes in the network infrastructure.

A typical computer network is constantly being modified or reconfigured in some way. Typical maintenance activities such as moving users to a different physical location, adding or removing computer devices, device configuration changes, malfunctioning equipment as well as changes to the logical topology make it more difficult for the network operator to maintain an accurate description of the network infrastructure. Frequently, changes are made to the infrastructure without properly documenting what changes have been made. The result of all of this activity is that over time, the network operator finds it increasingly difficult to detect any discrepancies between the expected state of the network infrastructure and its current state.

An additional problem relates to maintaining network security. An unauthorized user can mimic an authorized user's computer by supplying, for example, the authorized user's name, password, and Internet Protocol (IP) address. If the authorized user is not currently logged on to the network, there is no way of detecting this breach of security. Typical network infrastructures make it difficult to detect when devices have been added or reconfigured. Additionally, it is difficult to track the identity of authorized devices.

Accordingly, the need exists for a method for describing and comparing data center physical and logical topologies and device configurations. A further need exists for validating that the physical and logical connections as well as device configurations in a data center are the same as those expected by the data center operator. Additionally, a need exists to track devices authorized to exist within the environment and their physical location.

### SUMMARY OF THE INVENTION

The present invention provides a method for describing and comparing data center physical and logical topologies and device configurations. It also allows a data center operator to validate that the physical and logical connections as well as the device configurations in a data center are the same as those expected by the data center operator. The present invention also allows data center operators to track devices authorized to exist within the environment and their physical location.

The present invention compares a stored expected network infrastructure description with a current network infrastructure description gathered through the use of monitoring agents. The infrastructure descriptions are compared to discover whether the expected infrastructure is the same as the current infrastructure. Devices in the current infrastructure which are configured differently, added, or missing from the expected infrastructure description are listed as well as changes to the logical topology of the current network. The present invention facilitates monitoring the network infrastructure and detecting unauthorized changes or access to the network.

### BRIEF DESCRIPTION OF THE DRAWINGS

The accompanying drawings, which are incorporated in and form a part of this specification, illustrate embodiments of the present invention and, together with the description, serve to explain the principles of the invention.

FIG. 1 is a block diagram of an exemplary computer system upon which embodiments of the present invention may be practiced.

FIG. 2 is a block diagram of an exemplary managed computer network system upon which embodiments of the present invention may be practiced.

FIGS. 3A-3C are a flow chart of a process 300 for describing and comparing data center physical and logical topologies and device configurations in accordance with embodiments of the present invention.

FIG. 4 is an exemplary XML data type description (DTD) used to describe network devices in embodiments of the present invention.

### DETAILED DESCRIPTION OF THE PREFERRED EMBODIMENT

Reference will now be made in detail to the preferred embodiments of the present invention, examples of which are illustrated in the accompanying drawings. While the present invention will be described in conjunction with the preferred embodiments, it will be understood that they are not intended to limit the present invention to these embodiments. On the contrary, the present invention is intended to cover alternatives, modifications, and equivalents, which may be included within the spirit and scope of the present invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “storing,” “comparing,” “outputting,” “creating,” “collecting,” “converting,” or the like, refer to the action and processes of a computer system, or similar electronic computing device, that manipulates and transforms data represented as physical (electronic) quantities within the computer system's registers and memories into other data similarly represented as physical quantities within a computer system memories or registers or other such information storage, transmission or display devices.

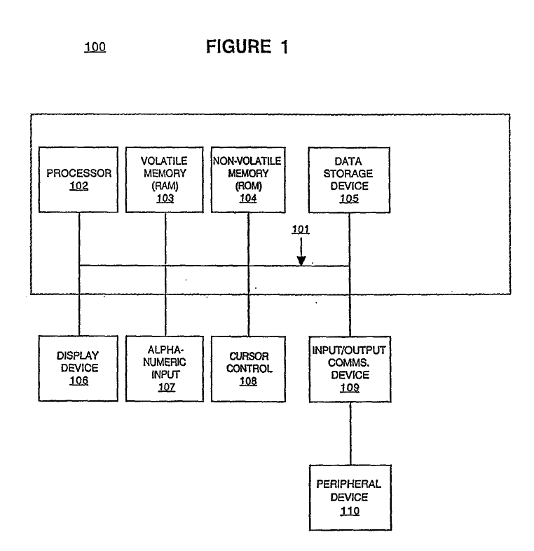

With reference to FIG. 1, portions of the present invention are comprised of computer-readable and computer-executable instructions that reside, for example, in computer system 100 which is used as a part of a general purpose computer network (not shown). It is appreciated that computer system 100 of FIG. 1 is exemplary only and that the present invention can operate within a number of different computer systems including general-purpose computer systems, embedded computer systems, laptop computer systems, hand-held computer systems, and stand-alone computer systems.

In the present embodiment, computer system 100 includes an address/data bus 101 for conveying digital information between the various components, a central processor unit (CPU) 102 for processing the digital information and instructions, a volatile main memory 103 comprised of volatile random access memory (RAM) for storing the digital information and instructions, and a non-volatile read only memory (ROM) 104 for storing information and instructions of a more permanent nature. In addition, computer system 100 may also include a data storage device 105 (e.g., a magnetic, optical, floppy, or tape drive or the like) for storing vast amounts of data. It should be noted that the software program for describing and comparing data center physical and logical topologies and device configurations of the present invention can be stored either in volatile memory 103, data storage device 105, or in an external storage device (not shown).

Devices which are optionally coupled to computer system 100 include a display device 106 for displaying information to a computer user, an alpha-numeric input device 107 (e.g., a keyboard), and a cursor control device 108 (e.g., mouse, trackball, light pen, etc.) for inputting data, selections, updates, etc. Computer system 100 can also include a mechanism for emitting an audible signal (not shown).

Returning still to FIG. 1, optional display device 106 of FIG. 1 may be a liquid crystal device, cathode ray tube, or other display device suitable for creating graphic images and alpha-numeric characters recognizable to a user. Optional cursor control device 108 allows the computer user to dynamically signal the two dimensional movement of a visible symbol (cursor) on a display screen of display device 106. Many implementations of cursor control device 108 are known in the art including a trackball, mouse, touch pad, joystick, or special keys on alpha-numeric input 107 capable of signaling movement of a given direction or manner displacement. Alternatively, it will be appreciated that a cursor can be directed and/or activated via input from alpha-numeric input 107 using special keys and key sequence commands. Alternatively, the cursor may be directed and/or activated via input from a number of specially adapted cursor directing devices.

Furthermore, computer system 100 can include an input/output (I/O) communications device (e.g., interface) 109 for interfacing with a peripheral device 110 (e.g., a computer network, modem, mass storage device, etc.). Accordingly, computer system 100 may be coupled in a network, such as a client/server environment, whereby a number of clients (e.g., personal computers, workstations, portable computers, minicomputers, terminals, etc.) are used to run processes for performing desired tasks (e.g., network monitoring, configuring, and comparing, etc.). In particular, computer system 100 can be coupled in a system for describing and comparing data center physical and logical topologies and device configurations.

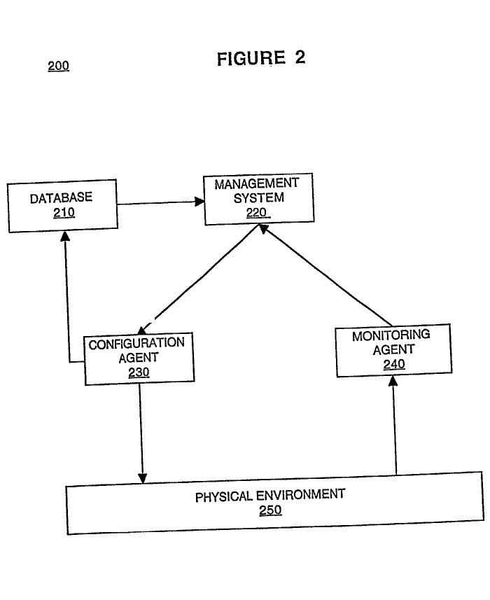

FIG. 2 is a block diagram of an exemplary managed network system 200 upon which embodiments of the present invention may be practiced. FIG. 2 represents a network having a data center where central control over the network can be maintained. In one embodiment, the physical environment 250 relies upon a switched network environment. In a switched network, the hubs used to couple devices in the network are replaced with switches. Unlike hubs which share network segments, switches provide a segment for each device connected to it. By replacing the hubs with switches, devices connected to the network can be physically isolated and/or located by the data center operators because there is a one-to-one mapping between a given device and the switch port to which it is connected.

A switched network allows data center operators to control network connectivity at a more granular level by programming configurations into each switch which determine the connections between devices. For example, the data center operators can create virtual topologies in which certain devices, though physically connected to the entire network, can communicate only with other designated devices. The logical topology of the network can, for example, be changed using the switches without physically touching any wiring. A switched network allows gathering an inventory of network devices because each device can be located and identified according to the port to which it is connected. A switched network enhances network security as physical access and the programming of the switch can be restricted to the data center operators.

In FIG. 2, a database 210 for storing an expected network infrastructure description is coupled with a configuration agent 230 and a management system 220. The logical topology of the network infrastructure (e.g., physical environment 250) is created or changed by management system 220 using configuration agent 230. Configuration agent 230 then stores the configuration information in database 210 as part of the expected network infrastructure description. Management system 220 is also coupled with a monitoring agent 240 which periodically collects current topology and configuration information of physical environment 250 and sends this information to management system 220. Management system 220 compares the expected network infrastructure description with the current network infrastructure description and automatically corrects deviations or flags them as errors or possible security violations to the data center operator.

In the context of the present invention, creating a switched network in the physical environment 250 allows the data center operator to verify that devices and ports are properly connected and configured by, for example, determining if a given device is connected to the correct port or if it has been moved to another. It also allows the data center operator to detect and locate devices which have been added to the network or reconfigured without authorization or which were not properly entered into database 210 using configuration agent 230.

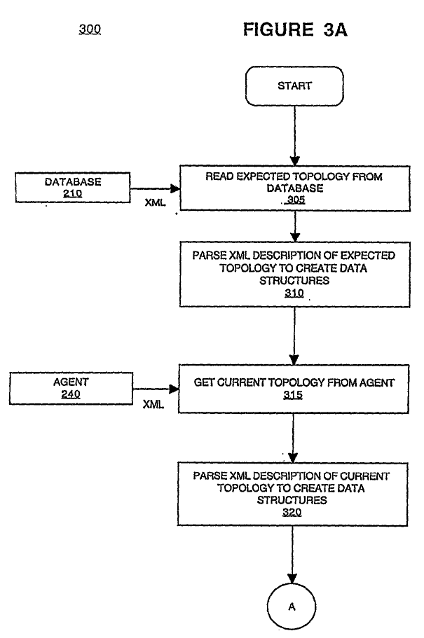

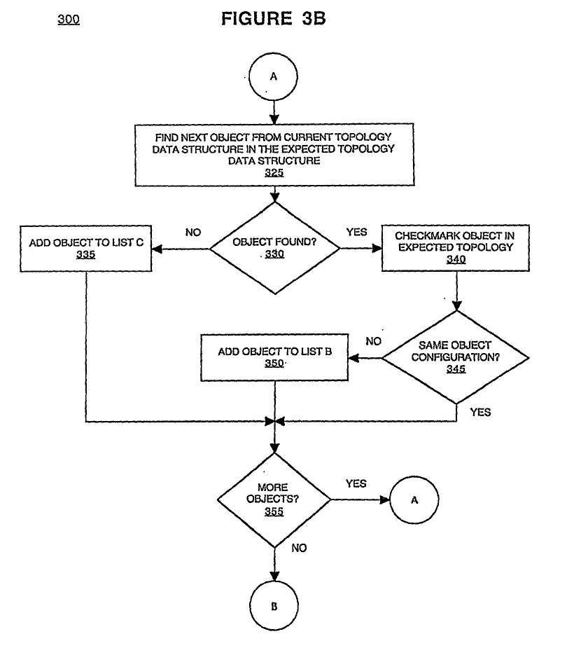

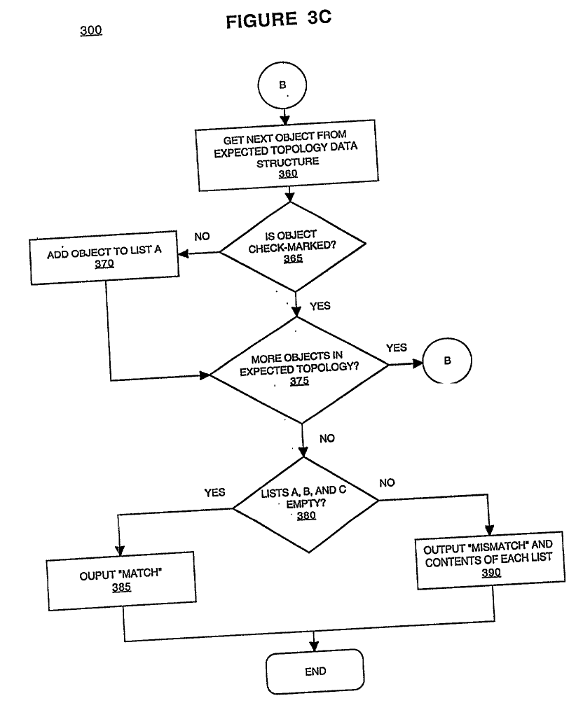

FIGS. 3A-3C are a flow chart of a process 300 for describing and comparing data center physical and logical topologies and device configurations in accordance with one embodiment of the present invention. Process 300 can be described as occurring in 3 phases. FIG. 3A shows the first phase in which the expected network infrastructure description and the current network infrastructure information are collected. In the second phase, which corresponds to FIG. 3B, devices in the current infrastructure description are compared to devices in the expected infrastructure description to detect any new devices in the network, any changed configurations of devices in the network, or devices or device interfaces that have been removed or have failed. In the third phase, which corresponds to FIG. 3C, devices in the expected infrastructure description are compared against the current infrastructure description to detect devices that were removed from the network without updating the expected network infrastructure description. Also in the third phase, a report is output describing any discrepancies between the infrastructure descriptions if there are any or, if there are no discrepancies, stating that the descriptions are identical. For purposes of clarity, the following discussion will utilize the block diagram of FIG. 2 in conjunction with FIGS. 3A-3C, to clearly describe one embodiment of the present invention.

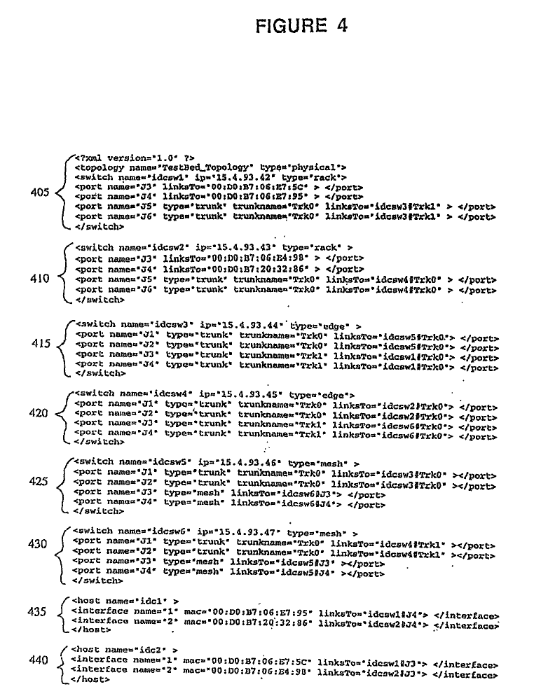

With reference to FIG. 2 and to step 305 of FIG. 3, the expected topology description is read from a database (e.g., database 210 of FIG. 2). Typically, a database uses the Structured Query Language (SQL) to construct a query. However, SQL is not well suited for making side by side comparisons. Therefore, in one embodiment of the present invention, this description is formatted using the Extensible Markup Language (XML). XML is frequently used to present structured data such as a database in a text format. By formatting the description using XML, an XML data type description (DTD) can be used to describe a given device in the network topology (as illustrated in FIG. 4). For each device in the topology, the description includes the name of the device and its configuration attributes (e.g., the Media Access Control or MAC address of each port or interface for the device) including a “linksTo” field identifying the device physically connected to this port. This facilitates detecting changes in the physical connections of the network and in graphically representing network topology in later steps of process 300.

With reference to FIG. 2 and to step 310 of FIG. 3, the XML description of the expected network infrastructure is parsed to create a graphical data structure. This graphical data structure represents the expected network infrastructure. Each device and port are represented in a graph, where nodes represent devices, links represent the connections between those devices, and both nodes and links have attributes that represent the expected configuration of the device or connection.

With reference to FIG. 2 and to step 315 of FIG. 3, the current network infrastructure description is collected. Again, in one embodiment the current network infrastructure description is an XML DTD description of each physical device in the current network infrastructure and its attributes. In one embodiment, the current infrastructure description is collected through the use of monitoring agents (e.g., monitoring agent 240 of FIG. 2) such as Simple Network Management Protocol (SNMP) agents that can query SNMP Management Information Bases (MIBs) on each physical device in network 250. In another embodiment, the current network infrastructure is collected by a program in management system 220 which gathers the information from the devices in network 250.

With reference to FIG. 2 and to step 320 of FIG. 3, the XML description of the current network infrastructure is parsed to create a graphical data structure. As in step 310, a graph is created showing devices in the current network infrastructure description and connections between those devices to facilitate a comparison with the expected network infrastructure description. The graphs of the expected network infrastructure and the current network infrastructure will be compared to discover any differences that may have occurred.

With reference to FIG. 2 and to step 325 of FIG. 3, a device from the current network infrastructure graph is searched for in the expected network infrastructure graph. The graphical structure used permits this decision to be made with relatively few operations on the node by simultaneous traversal of the two graphs (current infrastructure graph and expected infrastructure graph) without a global search for the device.

With reference to FIG. 2 and to step 330 of FIG. 3, a logic operation occurs to determine whether the device in the current network infrastructure graph of step 325 was found in the expected network infrastructure graph. If the device is found, flow chart 300 next proceeds to step 340. If the device is not found, it is considered a new device and flow chart 300 proceeds to step 335.

With reference to FIG. 2 and to step 335 of FIG. 3, the device from step 325 is added to list C. List C is a list of devices in the current network infrastructure description which are not found in the expected network infrastructure description. By only reporting the differences between the two network infrastructure descriptions, the present invention allows a data center operator to quickly determine changes to the network infrastructure such as a new device which has been added to the network without updating database 210. Rather than having to compare huge inventory lists to detect differences in the network infrastructure, the data center operator is presented with a much smaller list of the infrastructure discrepancies.

With reference to FIG. 2 and to step 340 of FIG. 3, the device from step 325 is checked or otherwise marked in the expected network infrastructure graph as having been read. If the device is found in the expected network infrastructure graph in step 330, the device is marked in the expected network infrastructure description as having been found in the current network infrastructure description. These marks are used later in the process to find missing devices or links.

With reference to FIG. 2 and to step 345 of FIG. 3, the current configuration of the device from step 325 is compared to the configuration of the same device in the expected network infrastructure description. If the device has the same configuration in the current infrastructure description as in the expected infrastructure description, flow chart 300 proceeds to step 355. If the configuration is different, flow chart 300 proceeds to step 350.

With reference to FIG. 2 and to step 350 of FIG. 3, the device from step 425 is added to list B. List B is a list of network devices which have a different configuration than what is found in the expected network infrastructure description. This can include hardware, firmware, and software configuration changes in network devices.

With reference to FIG. 2 and to step 355 of FIG. 3, a logic operation occurs to determine whether there are more devices in the current network infrastructure graph that have not been checked against the expected infrastructure graph. If there are more devices in the current network infrastructure graph, flow chart 300 returns to step 325. If there are no more unchecked devices in the current network infrastructure graph, flow chart 300 proceeds to step 360.

With reference to FIG. 2 and to step 360 of FIG. 3, a device in the expected network infrastructure graph is selected for comparison. Devices in the expected network infrastructure graph are now tested to discover devices from the expected network infrastructure graph which are missing from the current network infrastructure graph. The expected network infrastructure graph is traversed and any node or link which is not checkmarked is identified as missing or moved.

With reference to FIG. 2 and to step 365 of FIG. 3, a logic operation occurs to determine whether the device in the expected network infrastructure graph of step 360 has been checked or otherwise marked from step 340. This will indicate whether the device in question is in both the expected description and the current description. If the device has been checked, flow chart 300 proceeds to step 375. If the device has not been checked, flow chart 300 proceeds to step 370.

With reference to FIG. 2 and to step 370 of FIG. 3, the device from step 460 is added to list A. List A is a list of devices which are in the expected network infrastructure description which are not in the current network infrastructure description. This could be the result of a device being moved, disconnected, or otherwise disabled.

With reference to FIG. 2 and to step 375 of FIG. 3, a logic operation occurs to determine whether there are more devices in the expected network infrastructure graph. If there are more devices in the expected network infrastructure graph, flow chart 300 returns to step 360. If there are no more devices in the expected network infrastructure graph, flow chart 300 proceeds to step 380.

With reference to FIG. 2 and to step 380 of FIG. 3, a logic operation occurs to determine whether lists A, B, and C are empty. If lists A, B, and C are empty, flow chart 300 proceeds to step 385. If lists A, B, and C are not empty, flow chart 300 proceeds to step 390.

With reference to FIG. 2 and to step 385 of FIG. 3, a statement or message is output which indicates that the expected network infrastructure description matches the expected network infrastructure description. If lists A, B, and C are empty, that means that no differences between the expected network infrastructure description and the current network infrastructure description have been detected. A statement is output which states that the two network descriptions are identical.

With reference to FIG. 2 and to step 390 of FIG. 3, a statement is output which indicates that the expected network infrastructure description does not match the current network infrastructure description. This means that there is at least one discrepancy on either list A, B, or C which should be brought to the attention of the data center operator. By listing discrepancies between the two network infrastructure descriptions rather than all of the configuration information itself, the present invention reduces the amount of information a data center operator has to monitor and facilitates managing the network. The present invention further enhances network security by detecting unauthorized or reconfigured devices and notifying the data center operator if any are present.

FIG. 4 is an exemplary XML data type description (DTD) utilized in embodiments of the present invention. In FIG. 4 there are eight paragraphs, each of which presents information about the physical connectivity of a particular device. Paragraph 405 has XML formatting information which is required of each DTD. The next line gives the name of the network topology and states that the physical topology information is being presented. While FIG. 4 only shows physical connectivity information, the present invention is well suited for collecting other network infrastructure information as well including configuration information of the listed devices. The rest of paragraph 405 as well as paragraphs 410-430 show the name of a particular network switch, the IP address of the switch, a list of the ports for that switch, and what each of those ports is connected to.

Referring still to FIG. 4, paragraphs 435 and 440 show information about two computers connected to the network. Each paragraph shows the name of a particular computer as well as the name of each interface for that computer, the MAC address of each interface, and a “linksTo” field which identifies a particular switch and port which is connected to the interface.

The preferred embodiment of the present invention, a method for describing and comparing data center physical and logical topologies and device configurations, is thus described. While the present invention has been described in particular embodiments, it should be appreciated that the present invention should not be construed as limited by such embodiments, but rather construed according to the following claims.

What is claimed is:

1. A method for managing a network infrastructure comprising:
storing an expected network infrastructure description;
comparing said expected network infrastructure description with a current network infrastructure description; and
outputting a result of said comparing step, wherein differences between said expected network infrastructure description and said current network infrastructure description are displayed.

2. The method for managing a network infrastructure as recited in claim 1, wherein said network infrastructure is a switched network infrastructure.

3. The method for managing a network infrastructure as recited in claim 1, wherein said method further comprises changing said network infrastructure with a configuration agent and storing said change in said expected network infrastructure description.

4. The method for managing a network infrastructure as recited in claim 1, wherein said comparing further comprises collecting said current network infrastructure description.

5. The method for managing a network infrastructure as recited in claim 4, wherein said collecting of said current network infrastructure description further comprises using agents to collect said current network infrastructure description.

6. The method for managing a network infrastructure as recited in claim 1, wherein said comparing further comprises converting said expected network infrastructure description into an expected network infrastructure graphical description and converting said current network infrastructure description into a current network infrastructure graphical description.

7. The method for managing a network infrastructure as recited in claim 6, wherein said comparing further comprises comparing said expected network infrastructure graphical description with said current network infrastructure graphical description.

8. The method for managing a network infrastructure as recited in claim 1, wherein said outputting further comprises:
outputting a list of devices from said expected network infrastructure description which are missing from said current network infrastructure description;
outputting a list of devices from said current network infrastructure description having a different configuration from the configuration of said devices in said expected network infrastructure description; and
outputting a list of devices from said current network infrastructure description which are not described in said expected network infrastructure description.

9. The method for managing a network infrastructure as recited in claim 1, wherein said outputting further comprises:
outputting a message stating that said expected network infrastructure description and said current network infrastructure description are identical.

10. A computer system comprising:
a bus;
a memory unit coupled to said bus; and
a processor coupled to said bus, said processor for executing a method for managing a network infrastructure comprising:
storing an expected network infrastructure description;
comparing said expected network infrastructure description with a current network infrastructure description; and
outputting a result of said comparing step, wherein differences between said expected network infrastructure description and said current network infrastructure description are displayed.

11. The computer system as recited in claim 10, wherein said network infrastructure is a switched network infrastructure.

12. The computer system as recited in claim 10, wherein said method further comprises changing said network infrastructure with a configuration agent and storing said change in said expected network infrastructure description.

13. The computer system as recited in claim 10, wherein said comparing further comprises collecting said current network infrastructure description.

14. The computer system as recited in claim 13, wherein said collecting of said current network infrastructure description further comprises using agents to collect said current network infrastructure description.

15. The computer system as recited in claim 10, wherein said comparing further comprises converting said expected network infrastructure description into an expected network infrastructure graphical description and converting said current network infrastructure description into a current network infrastructure graphical description.

16. The computer system as recited in claim 15, wherein said comparing further comprises comparing said expected network infrastructure graphical description with said current network infrastructure graphical description.

17. The computer system as recited in claim 10, wherein said outputting further comprises:
outputting a list of devices from said expected network infrastructure description which are missing from said current network infrastructure description;
outputting a list of devices from said current network infrastructure description having a different configuration from the configuration of said devices in said expected network infrastructure description; and
outputting a list of devices from said current network infrastructure description which are not described in said expected network infrastructure description.

18. The computer system as recited in claim 10, wherein said outputting further comprises:
outputting a message stating that said expected network infrastructure description and said current network infrastructure description are identical.

19. A computer-usable medium having computer-readable program code embodied therein for causing a computer system to perform a method for managing a network infrastructure comprising:
storing an expected network infrastructure description;
comparing said expected network infrastructure description with a current network infrastructure description; and
outputting a result of said comparing step, wherein differences between said expected network infrastructure description and said current network infrastructure description are displayed.

20. The computer-usable medium as recited in claim 19, wherein said network infrastructure is a switched network infrastructure.

21. The computer-usable medium as recited in claim 19, wherein said method further comprises changing said network infrastructure with a configuration agent and storing said change in said expected network infrastructure description.

22. The computer-usable medium as recited in claim 19, wherein said comparing further comprises collecting said current network infrastructure description.

23. The computer-usable medium as recited in claim 22, wherein said collecting of said current network infrastructure description further comprises using agents to collect said current network infrastructure description.

24. The computer-usable medium as recited in claim 19, wherein said comparing further comprises converting said expected network infrastructure description into an expected network infrastructure graphical description and converting said current network infrastructure description into a current network infrastructure graphical description.

25. The computer-usable medium as recited in claim 24, wherein said comparing further comprises comparing said expected network infrastructure graphical description with said current network infrastructure graphical description.

26. The computer-usable medium as recited in claim 19, wherein said outputting further comprises:
outputting a list of devices from said expected network infrastructure description which are missing from said current network infrastructure description;
outputting a list of devices from said current network infrastructure description having a different configuration from the configuration of said devices in said expected network infrastructure description; and
outputting a list of devices from said current network infrastructure description which are not described in said expected network infrastructure description.

27. The computer-usable medium as recited in claim 19, wherein said outputting further comprises:
outputting a message stating that said expected network infrastructure description and said current network infrastructure description are identical.
